(19) United States
(12) Patent Application Publication
(10) Pub. No.: US 2010/0064207 A1
(43) Pub. Date: Mar. 11, 2010

(54) SYSTEM AND METHOD FOR DISPLAYING WIDGET CONTENTS USING A MOBILE DEVICE

(75) Inventor: SHIN-BO HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/497,642

(22) Filed: Jul. 3, 2009

(30) Foreign Application Priority Data
Sep. 10, 2008 (CN) 200810304451.9

(51) Int. Cl. G06F 17/00; G06F 3/14; G06F 3/048

(52) U.S. Cl. 715/206; 715/864; 715/810; 715/234

(57) ABSTRACT

A system and method for displaying widget contents using a mobile device separates a widget web page into a plurality of independent widgets. All the separated widgets are collected to generate a single widget display interface or a widget name list display interface. Contents of one separated widget are displayed on the single widget interface. Names of all the separated widgets are displayed on the widget name list display interface. Contents of a separated widget can be displayed if the name of the separated widget is selected from the widget name list display interface.

### BACKGROUND

1. Technical Field

Embodiments of the present disclosure relate to web pages displaying systems and methods, and more particularly to a system and a method for displaying widget contents using a mobile device.

2. Description of Related Art

Widgets are used on web pages and desktops to provide weather information, and stock information, for example. Many widgets may be displayed at once, thus making it inconvenient for a user to select a desired widget on a small screen of an electronic device.

Therefore, an effective system and method for displaying widget contents is desired to overcome the above-described shortcomings.

### BRIEF DESCRIPTION OF THE DRAWINGS

FIG. 1 is a block diagram of one embodiment of a system for displaying widget contents using a mobile device.

FIG. 2 is a flowchart of one embodiment of a method for displaying widget contents using a mobile device.

FIG. 3 and FIG. 4 are schematic diagrams illustrating one embodiment of displaying widgets.

### DETAILED DESCRIPTION

All of the processes described below may be embodied in, and fully automated via, functional modules executed by one or more general purpose processors. The functional modules may be stored in any type of computer-readable medium or other computer storage device. Some or all of the methods may alternatively be embodied in specialized computer hardware or communication apparatus.

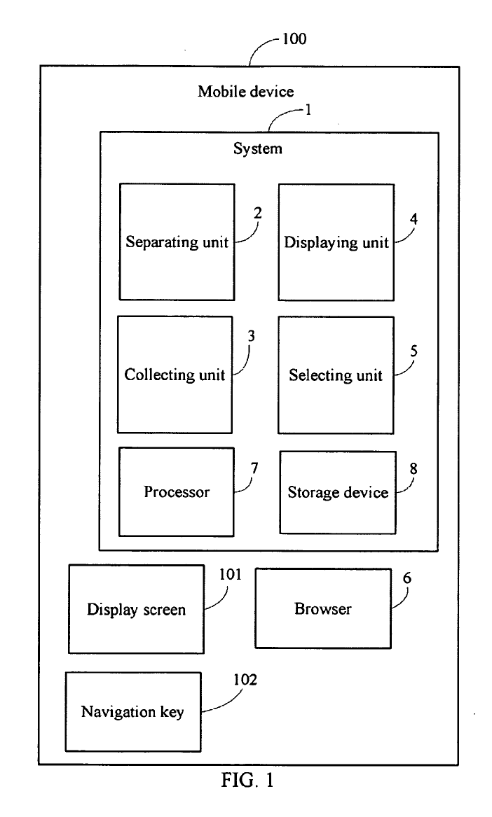

FIG. 1 is a block diagram of one embodiment of a system 1 for displaying widget contents using a mobile device 100. In one embodiment, the mobile device 100 may be a mobile phone with a small display screen 101. The system 1 may include a separating unit 2, a collecting unit 3, a displaying unit 4, and a selecting unit 5. It may be understood that one or more computerized codes of the function units 2-5 may be stored in a storage device 8 and be executed by one or more specialized or general purpose processors, such as a processor 7. The storage device 8 stores contents of the widgets. The mobile device 100 includes a browser 6 for displaying the contents of the widgets. In one embodiment, the browser 6 may be the Opera Mini browser.

A widget web page may comprise one or more widgets positioned and displayed on the widget web page. In one example, the separating unit 2 may separate a widget web page into a plurality of independent widgets, and allocate an identifier (ID) to each of the plurality of independent widgets. For example, if a user wants to browse a Google widget web page, which includes 3 widgets (e.g., a map widget, a calendar widget, and an email widget), the separating unit 2 separates the Google widget web page into three independent widgets according to hypertext mark-up language (HTML) codes of each widget of the web page.

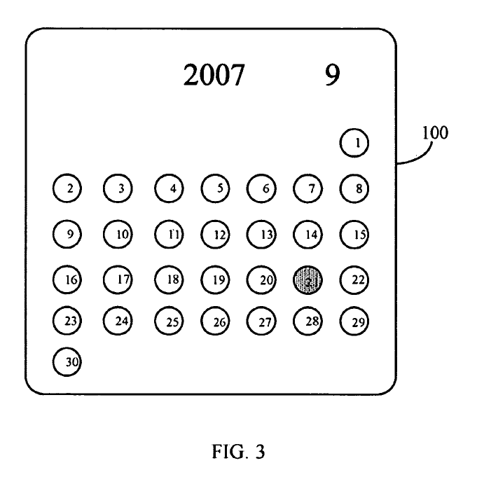

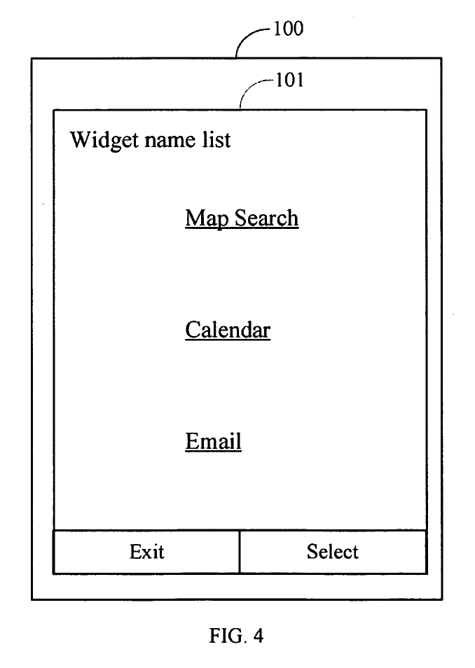

The collecting unit 3 provides a single widget display interface and a widget name list display interface which includes names of all the separated widgets for the user to select. The collecting unit 3 collects all the separated widgets to generate the selected display interface on the browser 6. The collecting unit 3 generates the single widget display interface as shown in FIG. 3, for example. The display interface is shown in FIG. 4 if the user selects the widget name list display interface.

The displaying unit 4 searches contents of the single widget according to the ID of the single widget from the storage device 8, and displays the contents of the single widget on the display screen 101. For example, FIG. 3 shows contents of a single calendar widget. The contents of the map search widget may be a map of the United States, while contents of the email widget may comprise email information. The single widget on the display screen 101 may be changed to display a next single widget according to a navigation instruction generated by a navigation key 102 of the mobile device 100. The displaying unit 4 displays the widget name list, for example, FIG. 4 shows the widget name list including names of all the widgets. In FIG. 4, the names of the widgets include a map search, a calendar, and an email.

The selecting unit 5 selects a widget from the widget name list. The displaying unit 4 searches contents of the selected widget according to the ID of the selected widget from the storage device 8 and displays the contents of the selected widget on the display screen 101. For example, the selecting unit 5 may select a “map search” from the widget name list in FIG. 4, then the displaying unit 4 may search contents of the “map search” widget from the storage device 8 and display the contents of the “map search” on the display screen 101.

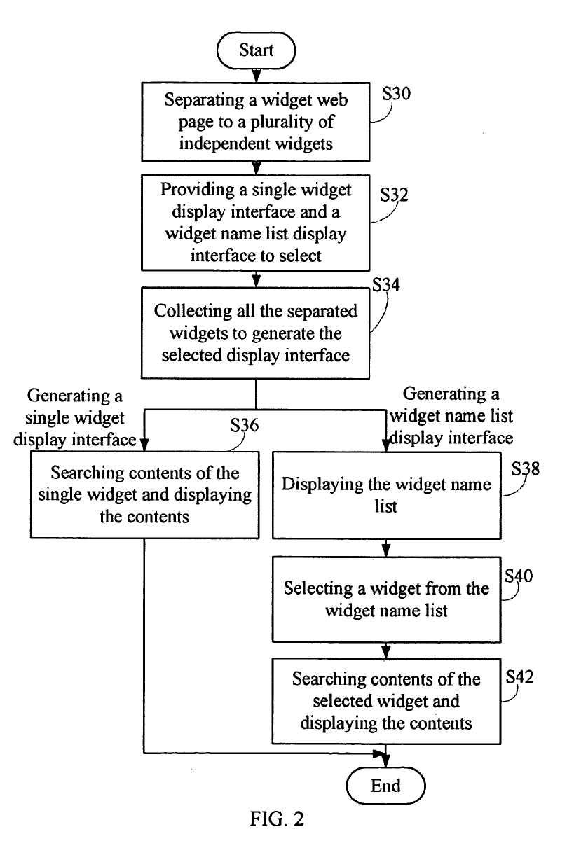

FIG. 2 is a flowchart of one embodiment of a method for displaying widget contents using a mobile device. Depending on the embodiment, additional blocks may be added, others removed, and the ordering of the blocks may be changed.

In block S30, the separating unit 2 separates a widget web page into a plurality of independent widgets. The separating unit 2 further allocates an identifier (ID) to each of the plurality of the independent widgets.

In block S32, the collecting unit 3 provides a single widget display interface and a widget name list display interface which includes names of all the separated widgets for the user to select.

In block S34, the collecting unit 3 collects the separated independent widgets to generate the selected display interface on the browser 6.

In block S34, if the collecting unit 3 generates a single widget on the browser 6, in block S36, the displaying unit 4 searches contents of the single widget from the storage device 8 according to the ID of the single widget and displays the contents of the single widget on the display screen 101. In one embodiment, the single widget may be changed to a next single widget according to a navigation instruction generated by the navigation key 102 of the mobile device 100.

In block S34, if the collecting unit 3 generates a widget name list including names of all the collected widgets, in block S38, the displaying unit 4 displays the widget name list on the display screen 101.

In block S40, the selecting unit 5 selects a widget from the widget name list.

In block S42, the displaying unit 4 searches contents of the selected widget from the storage device 8 according to the ID of the selected widget and displays the contents of the selected widget on the display screen 101.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for displaying widget contents using a mobile device, the system comprising:
at least one processor to execute one or more programs stored in a storage device of the mobile device, the one or more programs comprising:
a separating unit to separate a widget web page into a plurality of independent widgets, and to allocate an identifier (ID) to each of the plurality of independent widgets;
a collecting unit to collect all the separated widgets, and generate a single widget display interface or a widget name list display interface comprising names of all the separated widgets;
a selecting unit to select a widget from the widget name list; and
a displaying unit to search contents of the single widget or the selected widget from the storage device according to the ID of the single widget or the selected widget, and to display the contents of the single widget or the selected widget on a display screen of the mobile device.

2. The system of claim 1, wherein the collecting unit is also to provide a single widget display interface and a widget name list display interface for a user to select.

3. The system of claim 1, wherein the single widget on the display screen is changed to display a next single widget according to a navigation instruction generated by a navigation key of the mobile device.

4. The system of claim 1, wherein the displaying unit displays the widget name list on the display screen.

5. A method for displaying widgets contents using a mobile device, the method comprising:
separating a widget web page into a plurality of independent widgets, and allocating an identifier (ID) to each of the plurality of independent widgets;
collecting all the separated widgets, and generating a single widget display interface or a widget name list display interface comprising names of all the separated widgets;
selecting a widget from the widget name list if the widget name list display interface is generated;
searching contents of the selected widget from a storage device of the mobile device and displaying the contents of the selected widget on a display screen of the mobile device; and
searching contents of the single widget from the storage device if the single widget display interface is generated, and displaying the contents of the single widget on the display screen.

6. The method of claim 5, further comprising:
providing a single widget display interface and a widget name list display interface for a user to select.

7. The method of claim 5, further comprising:
changing the single widget on the display screen to display a next single widget according to a navigation instruction generated by a navigation key of the mobile device.

8. The method of claim 5, further comprising:
displaying the widget name list when the widget name list display interface is generated.

9. A computer-readable medium having stored therein instructions that, when executed by a mobile device, cause the mobile device to perform a method for displaying widgets contents, the method comprising:
separating a widget web page into a plurality of independent widgets, and allocating an identifier (ID) to each of the plurality of independent widgets;
collecting all the separated widgets, and generating a single widget display interface or a widget name list display interface comprising names of all the separated widgets;
selecting a widget from the widget name list if the widget name list display interface is generated;
searching contents of the selected widget from a storage device of the mobile device and displaying the contents of the selected widget on a display screen of the mobile device; and
searching contents of the single widget from the storage device if the single widget display interface is generated, and displaying the contents of the single widget on the display screen.

10. The medium of claim 9, further comprising:
providing a single widget display interface and a widget name list display interface for a user to select.

11. The medium of claim 9, further comprising:
changing the single widget on the display screen to display a next single widget according to a navigation instruction generated by a navigation key of the mobile device.

12. The medium of claim 9, further comprising:
displaying the widget name list when the widget name list display interface is generated.
